(19) United States
(12) Patent Application Publication
(10) Pub. No.: US 2021/0110189 A1
(43) Pub. Date: Apr. 15, 2021

(54) CHARACTER-BASED TEXT DETECTION AND RECOGNITION

(71) Applicant: Shenzhen Malong Technologies Co., Ltd., Shenzhen City (CN)

(72) Inventors: Weilin HUANG, Shenzhen City (CN); Matthew Robert SCOTT, Shenzhen City (CN); Linjie XING, Shenzhen City (CN)

(21) Appl. No.: 16/672,883

(22) Filed: Nov. 4, 2019

Related U.S. Application Data
(60) Provisional application No. 62/915,008, filed on Oct. 14, 2019.

(51) Int. Cl. G06K 9/32; G06K 9/62; G06T 7/70; G06K 9/20

(52) U.S. Cl. CPC G06K 9/325; G06K 9/6256; G06T 7/70; G06T 2207/20081; G06K 9/2072; G06K 9/6253; G06K 2209/01; G06K 9/6262

(57) ABSTRACT

Aspects of this disclosure include technologies for character-based text detection and recognition. The disclosed single-stage model is configured for joint text detection and word recognition in natural images. In the disclosed solution, a character recognition branch is integrated into a word detection model. This results in an end-to-end trainable model that can implement text detection and word recognition jointly. Further, the disclosed technical solution includes an iterative character detection method, which is configured to generate character-level bounding boxes on real-world images by using synthetic data first.

### CROSS-REFERENCE TO RELATED APPLICATIONS

This application claims the benefit of U.S. Provisional Application No. 62/915,008, filed Oct. 14, 2019, entitled “Character-Based Text Detection and Recognition,” the benefit of priority of which is hereby claimed, and which is incorporated by reference herein in its entirety.

### BACKGROUND

Optical character recognition (OCR) has been widely used to convert images of typed, handwritten, or printed text into machine-encoded text. Machine-encoded text can then be electronically stored, displayed, searched, edited, or used for more advanced machine processes such as machine translation, text-to-speech, data mining, cognitive computing, etc. With so many applications, OCR has been an active field of research in pattern recognition, artificial intelligence, and computer vision.

Recognizing scene text is a challenging problem related to OCR. Scene text refers to text in an image depicting an outdoor environment in general, such as natural images taken by cameras. Conventional OCR technologies are largely developed to handle text from documents scanned in a relatively controlled environment. However, scene text, such as the text on signs and billboards in a landscape photo, typically exhibits a significant degree of variance in appearances from uncontrolled outdoor environment, which prove to be challenging for conventional OCR technologies to handle. By way of example, scene text varies in shape, font, color, illumination, fuzziness, composition, alignment, layout, etc.

Given the rapid growth of portable, wearable, or mobile imaging devices, understanding scene text has become more important than ever. Many state-of-the-art systems can detect general objects in natural images, such as roads, cars, pedestrians, obstacles, etc., but fail to understand the scene text, which hinders such system from understanding the semantics of the environment. New technologies are needed to detect and recognize scene text.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

This disclosure includes a technical solution for character-based text detection and recognition for scene text or text in other environments. To do that, in various embodiments, after receiving an image with a representation of a word having a plurality of characters, the disclosed system detects a location of a character of the plurality of characters and concurrently recognizes the character, based on a machine learning model with an iterative character learning approach. Further, the disclosed system can generate an indication of the location of the character or annotate the image with corresponding characters.

The disclosed technical solution includes a single-stage model that can process text detection and recognition simultaneously in one pass and directly output the bounding boxes of characters and words with corresponding annotated character scripts. Further, the disclosed technical solution utilizes characters as basic units, which overcomes the main difficulty of many existing approaches. This results in a simple, compact, yet powerful single-stage model that works reliably on multi-orientation and curved text.

In various aspects, systems, methods, and computer-readable storage devices are provided to improve a computing device's ability to detect and recognize text even in natural images. One aspect of the technology described herein is to improve a computing device's ability to jointly detect and recognize text in a single-stage model. Another aspect of the technology described herein is to improve a computing device's ability to use an iterative character learning approach for text recognition. Another aspect of the technology described herein is to improve a computing device's ability for various cognitive computing tasks, including generating character-level or word-level bounding boxes, annotating natural images with semantic labels, providing contextual information based on scene text, dynamically augmenting user interface with semantic information, recognizing signs for autonomous or assisted driving, etc.

### BRIEF DESCRIPTION OF THE DRAWING

The technology described herein is illustrated by way of example and not limited in the accompanying figures in which like reference numerals indicate similar elements and in which:

FIG. 1 is a block diagram illustrating an exemplary operating environment for implementing character-based text detection and recognition, in accordance with at least one aspect of the technology described herein;

FIG. 2 illustrates some exemplary practical applications enabled by the character-based text detection and recognition technology, in accordance with at least one aspect of the technology described herein;

FIG. 3 illustrates an augmented image with recognized scene text, in accordance with at least one aspect of the technology described herein;

FIG. 4 is a schematic representation illustrating an exemplary network configured for character-based text detection and recognition, in accordance with at least one aspect of the technology described herein;

FIG. 5 is a schematic representation illustrating an exemplary iterative character learning process, in accordance with at least one aspect of the technology described herein;

FIG. 6 is a flow diagram illustrating a first exemplary process of character-based text detection and recognition, in accordance with at least one aspect of the technology described herein;

FIG. 7 is a flow diagram illustrating a second exemplary process of character-based text detection and recognition, in accordance with at least one aspect of the technology described herein;

FIG. 8 is a flow diagram illustrating a third exemplary process of character-based text detection and recognition, in accordance with at least one aspect of the technology described herein; and

FIG. 9 is a block diagram of an exemplary computing environment suitable for use in implementing various aspects of the technology described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the term “based on” generally denotes that the succedent condition is used in performing the precedent action.

Recognizing scene text or text reading in natural images has long been modeled as two separate tasks, i.e., text detection and recognition, which are learned and implemented independently in a two-stage framework. Text detection aims to predict a bounding box for each text instance (e.g., a word or a text line) in natural images. Traditional systems for text detection are mainly built on a general object detector with some modifications. Recent approaches for this task are mainly extended from an object detection or segmentation framework.

On the other hand, the goal of text recognition is to recognize a sequence of character scripts from a cropped word image. Text recognition mainly shares similar ideas as speech recognition, which cast text recognition into a sequence-to-sequence task and employ recurrent neural networks (RNNs) for the task. Some approaches exploit convolution neural networks (CNNs) to encode the raw input image to a sequence of features and then apply an RNN to the feature sequence to yield confidence maps. Some approaches encode the raw input images as a single feature vector with an RNN. Afterwards, another RNN is used to decode the final recognition results from the single feature vector. Some approaches employ ROI-pooling to obtain the features for text recognition from the text detection backbone. Many these approaches at least require word-level ROIs and multiple stages, thus also suffering from many limitations as discussed below.

Significant progress in scene text recognition has been made recently by using deep learning based technologies. For example, text recognition can be cast into a sequence labeling problem, where various recurrent models with features extracted from a convolutional neutral network (CNN) have been developed. However, even with deep learning based technologies, text detection and recognition are still being advanced individually as two separate tasks in the two-stage framework.

The current two-stage framework often suffers from a number of limitations. Learning the two tasks independently would result in a sub-optimization problem, making it difficult to fully explore the potential of text nature, where text detection and recognition can potentially work collaboratively by providing strong complementary information to each other, thus significantly improving the performance. Further, the current two-stage framework often requires complex implementation of multiple sequential steps, resulting in a more complicated system and unpredictable outcomes. By way of example, the text recognition task usually heavily relies upon the text detection results. The performance of the current two-stage framework would suffer due to unsatisfactory modeling at the text detection stage regardless the quality of the modeling at the text recognition stage. This also makes any evaluation of text recognition models less reliable. In general, the text recognition stage may suffer from its dependency on the text detection stage, and the two stages lack synergy.

Some effort has been devoted to developing a unified framework for implementing text detection and recognition. These approaches may achieve text detection and recognition together, but they are built on two-stage models with numerous known limitations. For example, the recognition branch often explores a recurrent neural network (RNN) based sequential model, which is difficult to optimize, and requires a significantly larger amount of training samples, compared to the detection task. This makes it difficult to train a CNN-based text detector and an RNN-based recognizer jointly, and the performance is heavily depended on the complicated training scheme, which is the central issue that impedes the development of a united framework.

Further, the two-stage models commonly require cropping and region of interest (ROI) pooling operations, while text instances are different from general objects and can have large variances in shape, in particular for a multi-orientation or curved text. This makes it difficult to use the cropping and ROI operations to precisely crop a compact text region for the multi-orientation or curved text instance, leading to significant performance degradation on the recognition task, due to a large amount of background information included in the cropped region. Many past approaches tried to enhance text information computed from ROIs, but they still failed on curved text.

In addition, many current high-performance models try using a word instance (e.g., in English) as a detection unit to achieve reliable results on detection as a word may provide stronger contextual information than an individual character. However, word-level detection gives rise to the main difficulty in recognition, which often transforms the task into a sequence labelling problem, where an RNN model may be required with additional operations such as attention mechanisms. Besides, words may not be clearly distinguishable in some languages, such as Chinese, where text instances are separated more clearly by characters or text lines, rather than words.

Previous systems mainly focus on word-level detection and was commonly evaluated at the word level in many benchmarks. Typically, text detection was not considered jointly with text recognition. Further, character detection was not emphasized due to additional post-processing steps to group characters into words, which are heuristic and can be complicated when multiple word instances are located closely.

In summary, scene text detection and recognition were traditionally considered as two separate tasks which were handled independently. Recent effort has been devoted to developing a unified framework for both tasks. However, existing joint models are built on two-stage models involving ROI pooling, making it difficult to train the two tasks collaboratively. The ROI operation also degrades the performance of recognition tasks, particularly for irregular text instances. Existing approaches for joint text detection and recognition are mostly built on RNN-based word recognition, which can be integrated into a text detection framework, resulting in two-stage models. RNN-based models may be modified to identify character location implicitly by using CTC or attention mechanism. This allows them to be trained at the word level and overcome the challenge of character segmentation, which is an important issue of conventional approaches for text recognition. However, the RNN sequential models with CTC or attention mechanism inevitably make the model complicated and difficult to train by requiring a large amount of training samples, because word-level optimization has a significantly larger search space than character recognition, which inevitably increases the learning difficulty.

In this disclosure, convolutional character networks are provided for text detection and recognition. The disclosed single-stage model can process text detection and recognition simultaneously in one pass. To do that, in various embodiments, after receiving an image with a representation of a word having a plurality of characters, the disclosed system detects a location of a character of the plurality of characters and concurrently recognizes the character, based on a machine learning model with an iterative character learning approach. Further, the disclosed system can generate an indication of the location of the character or annotate the image with corresponding characters. Resultantly, the disclosed system can directly output the bounding boxes of characters or words with corresponding character scripts.

As disclosed, a character is used as a more clearly-defined unit that generalizes better over various languages. Importantly, character recognition can be implemented with a CNN model rather than using an RNN-based sequential model. As character is utilized as the basic element, the disclosed system overcomes the main difficulty of existing approaches that attempted to optimize text detection jointly with an RNN-based recognition branch. This results in a simple, compact, yet powerful single-stage model that works reliably on multi-orientation and curved text.

In the disclosed technical solution, a new joint branch is used for character detection and recognition. The new branch can be integrated seamlessly into an existing text detection framework. The new branch uses characters as basic recognition units, which allows the disclosed system to avoid using an RNN-based recognition and ROI cropping-pooling operations, setting the disclosed approach apart from existing two-stage approaches.

Further, the disclosed technical solution includes an iterative character detection method, which is able to automatically generate character-level bounding boxes on real-world images by using synthetic data. This enables the disclosed system to work practically on real-world images, without prerequisites of additional character-level bounding boxes.

In contrast to previous multiple-stage models, a single-stage model is developed here for joint text detection and recognition in the single stage. The disclosed technical solution includes a single-stage end-to-end trainable model, where the dual tasks of text detection and recognition can be trained collaboratively by sharing convolutional features. Shared convolutional features for text detection and recognition benefit both tasks so that the detection results can be significantly improved.

Advantageously, for joint text detection and recognition, by leveraging characters as basic units, the disclosed solution provides a one-stage solution for both tasks, with significant performance improvements over the state-of-the-art results achieved by more complex two-stage frameworks. Because the disclosed solution implements direct character detection and recognition, jointly with text instance detection, it avoids the RNN-based word recognition, which is typically used in conventional systems, resulting in a simple, compact, yet powerful model that directly outputs the bounding boxes for characters, words, or other text instances, with corresponding character labels, as shown in connection with various figures herein.

Advantageously, the disclosed solution presents a new single-stage model for joint text detection and word recognition in natural images. In the disclosed solution, a CNN-based character recognition branch is integrated seamlessly into a CNN-based word detection model. This results in an end-to-end trainable model that can implement two tasks jointly in one shot, setting it apart from existing RNN-integrated two-stage frameworks. Furthermore, in the disclosed solution, an iterative character detection method is developed to generate character-level bounding boxes on real-world images. This iterative character detection method does not require character-level annotations and works on real-world images.

Advantageously, the disclosed single-stage model can be used for text detection and word recognition not only for scene text but also for product text, such as trademarks, labels, or other content that is used to describe the product. Enabled by the disclosed technologies, one practical application is for product recognition based on the recognized text printed on a product, such as by recognizing a trademark, a product name (e.g., COCONUT WATER), a label (e.g., USDA ORGANIC), a quantity description (e.g., 14 FL OZ), etc.

To demonstrate the advantages of this single-stage model, experiments were conducted on various datasets and benchmarks, e.g., ICDAR 2015, MTL 2017 and Total Text, where the disclosed system consistently outperforms other state-of-the-art approaches by a large margin on both text detection and end-to-end recognition.

ICDAR 2015 includes 1,500 images which were collected by using Google Glasses. In an experiment, the training set has 1,000 images, and the remained 500 images are used for evaluation. This dataset includes arbitrary orientation, very small-scale and low-resolution text instances with word-level annotations.

ICDAR MLT 2017 is a large-scale multi-lingual text dataset, containing 7,200 training images, 1,800 validation images, and 9,000 testing images. This dataset is composed of images from 9 languages.

Total-Text consists of 1,555 images with multiple text orientations, including Horizontal, Multi-Oriented, and Curved. The training split and test split have 1,255 images and 300 images, respectively.

In various experiments, the disclosed system shows significant improvements with a generic lexicon on ICDAR 2015. Further, the disclosed system model can achieve comparable results on ICDAR 2015, even by completely removing the lexicon.

The experimental results demonstrate that text detection and recognition can work effectively and collaboratively in this single-stage model, leading to more significant performance improvements. Further, this single-stage model can also work reliably on curved text. Furthermore, this single-stage model is more compact with less parameters compared with conventional systems. By way of example, in one embodiment, this single-stage model allows for a light-weight character branch based on CNN which just has about 1M parameters, compared to about 6M of the RNN-based recognition branch designed in FOTS.

Experimentally, this single-stage model achieves new state-of-the-art performance on text detection on various benchmarks, which improves recently strong baselines by a large margin. For example, in the term of f-measure, significant improvements are achieved on the ICDAR 2015, on the Total-Text for curved text, and on the ICDAR 2017 MLT. Further, this single-stage model can generalize well for detecting challenging text instances, e.g., curved text, while other conventional approaches often fail.

By jointly optimizing with text recognition, the disclosed system improves the detection performance as well. This suggests that the disclosed single-stage model with non-approximate joint optimization is more efficient than its two-stage counterparts and allows text detection and text recognition to work more effectively and collaboratively. This enables the disclosed system with higher capability for identifying extremely challenging text instances and also with stronger robustness that reduces false detection.

Experimentally, for end-to-end joint text detection and recognition, the disclosed system is compared with recent state-of-the-art methods on ICDAR 2015 and Total-Text in an embodiment. For ICDAR 2015, by using a same backbone ResNet-50, the disclosed system outperforms FOTS in terms of generic lexicon. Unlike FOTS, which employs a cumbersome recognition branch to achieve the performance, the disclosed system reduces the number of parameters by a factor of 5 (i.e., from about 6M to about 1M). Importantly, the disclosed model can work reliably without a lexicon, which is even comparable to that of FOTS by using a generic lexicon. This result can be further improved by using a stronger backbone (e.g., Hourglass-88) with multi-scale inference. These results demonstrate strong capability of the disclosed one-stage model, making it more applicable to real-world applications where a lexicon is not always available.

In one embodiment, an Hourglass-like backbone named Hourglass-57 is used, which has the similar number of model parameters to that of FOTS (34.96M vs. 34.98M). In various experiments, the disclosed system outperforms FOTS in terms of generic lexicon, which suggests that this single-stage model is a more compact and efficient model. With a more powerful backbone Hourglass-88, the disclosed system sets a new state-of-the-art single-scale performance on the benchmark and improves the previously best model FOTS considerably, e.g., in terms of generic lexicon. Further, with multi-scale inference, the disclosed system also surpasses previous state-of-the-art methods by a large margin.

When conducting experiments on Total-Text, which is mainly composed of curved text, the disclosed system demonstrates its capabilities for detecting curved text. In some experiments, no lexicon is used in the end-to-end recognition task. The disclosed system improves the previous state-of-the-art methods significantly in text detection and in end-to-end recognition. Moreover, unlike conventional end-to-end methods, which are often limited by using a word bounding box prior to the end-to-end recognition, the disclosed system, by detecting characters directly, eliminates the requirement of word bounding boxes which are not well-defined for the curved texts.

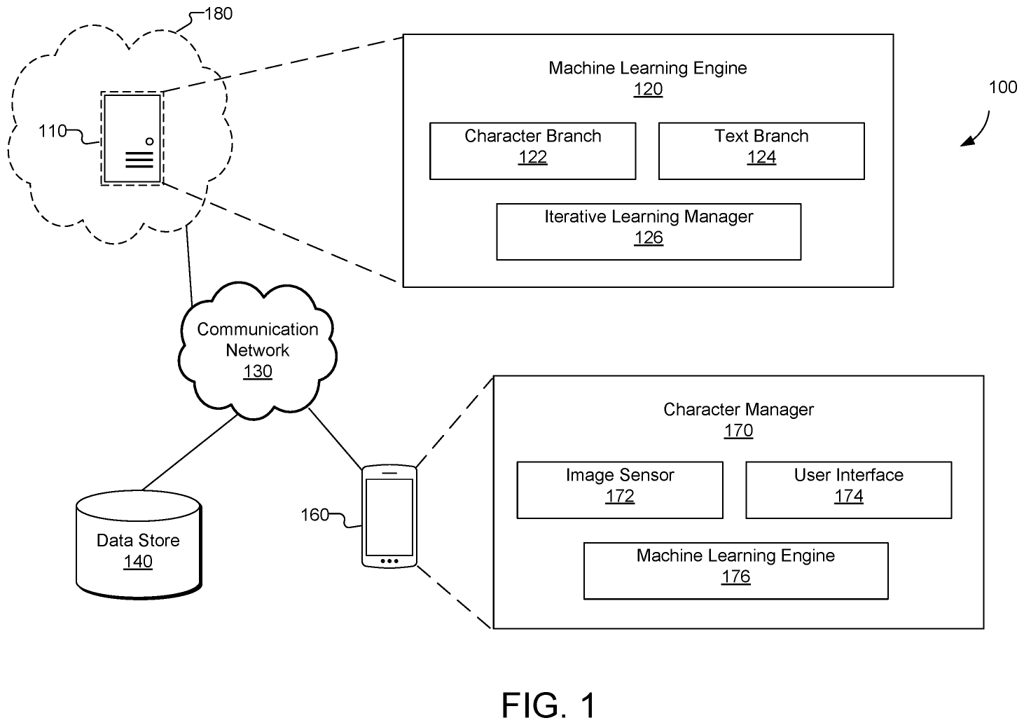

Having briefly described an overview of aspects of the technology described herein, an exemplary operating environment in which aspects of the technology described herein may be implemented is described below. Referring to the figures in general and initially to FIG. 1 in particular, an exemplary operating environment for implementing synthesizing an image is shown. This operating environment is merely one example of a suitable computing environment and is not intended to suggest any limitation as to the scope of use or functionality of aspects of the technology described herein. Neither should this operating environment be interpreted as having any dependency or requirement relating to any one component nor any combination of components illustrated.

Turning now to FIG. 1, a block diagram is provided showing an operating environment 100 in which some aspects of the present disclosure, including character-based text detection and recognition, may be employed.

It should be understood that this and other arrangements described herein are set forth only as examples. Other arrangements and elements (e.g., machines, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

In addition to other components not shown in FIG. 1, this operating environment includes computer system 110, which is located in a computing cloud 180 in some embodiments.

In various embodiments, computer system 110 includes machine learning engine 120, which further includes character branch 122, text branch 124, and iterative learning manager 126.

Computer system 110 is operatively coupled with data store 140 and mobile device 160 via communication network 130. In various embodiments, mobile device 160 includes character manager 170, which in turn includes image sensor 172, user interface 174, and machine learning engine 176.

Both computer system 110 and mobile device 160 have local storages, but can access data store 140 to retrieve or store data, particularly for training a one-stage model for text detection and recognition.

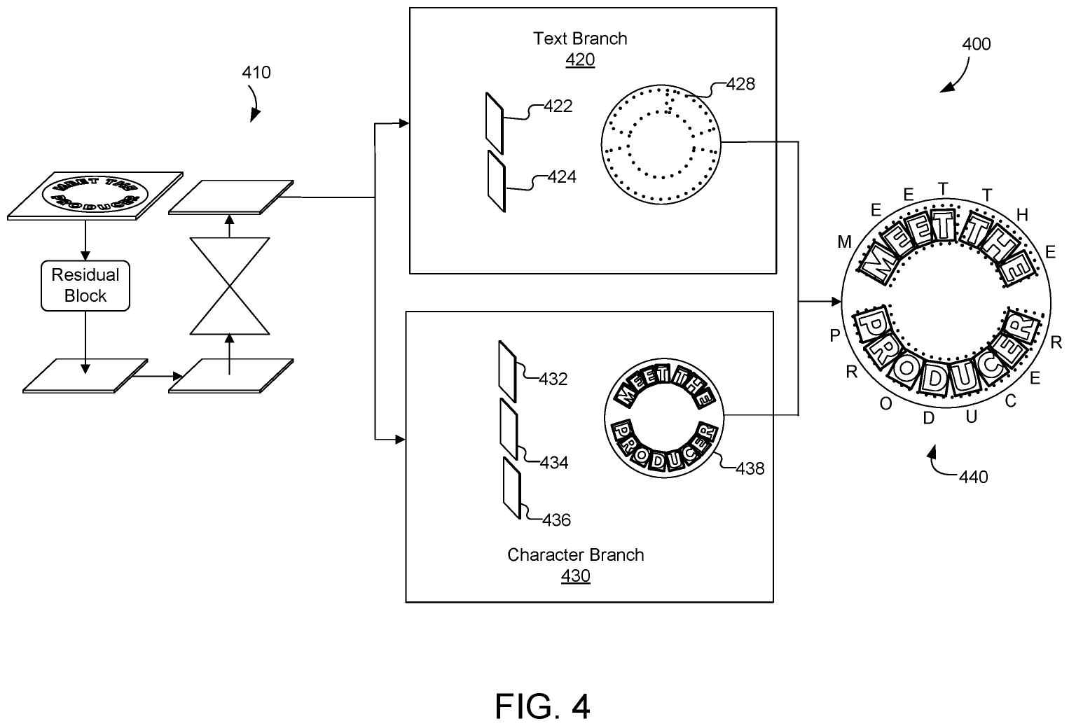

Referring back to machine learning engine 120, character branch 122 is configured to use characters as basic units for detection and recognition. Character branch 122 can output a character-level bounding box with corresponding character labels. Text branch 124 is configured to identify text instances at a high level concept, such as words or text lines. In some embodiments, text branch 124 can group the detected characters into text instances. The processes associated with character branch 122 and text branch 124 are further discussed in detail in connection with FIG. 4.

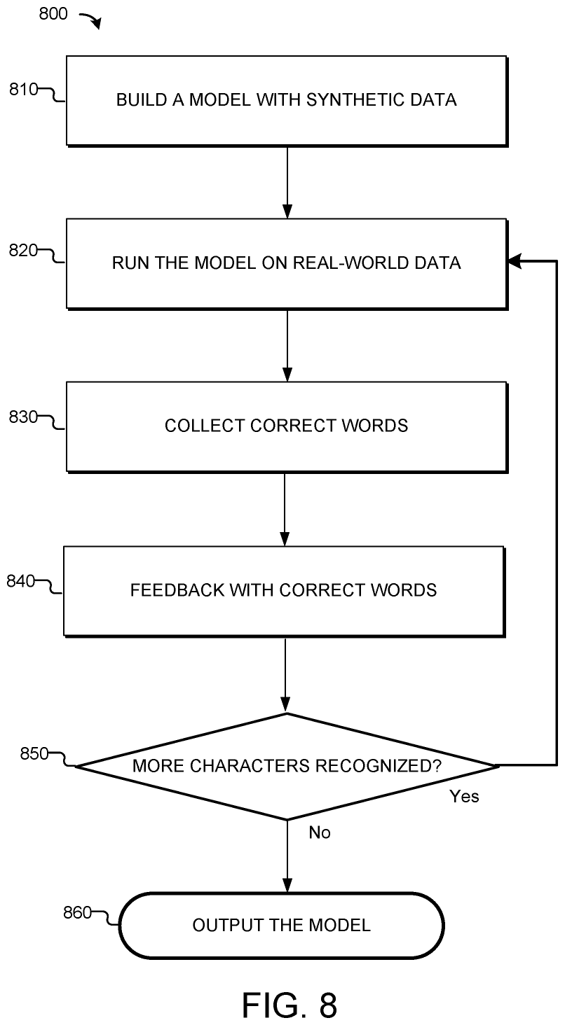

Iterative learning manager 126 is configured to enable this one stage model to automatically identify characters by leveraging synthetic data, where multilevel supervised information can be generated easily. This character iterative learning approach allows machine learning engine 120 to train the one-stage model from synthetic data and then transform the learned capability of character detection to real-word images gradually. This enables the model to automatically detect characters in real-world natural images and achieve weakly-supervision learning by just using word-level supervision. This learning approach is further discussed in detail in connection with FIG. 8.

Referring back to character manager 170 in mobile device 160, machine learning engine 176 has similar structures and functions as machine learning engine 120 in computer system 110 in some embodiments. In other embodiments, machine learning engine 176 can receive and apply the one-stage model trained by machine learning engine 120 for text detection and recognition.

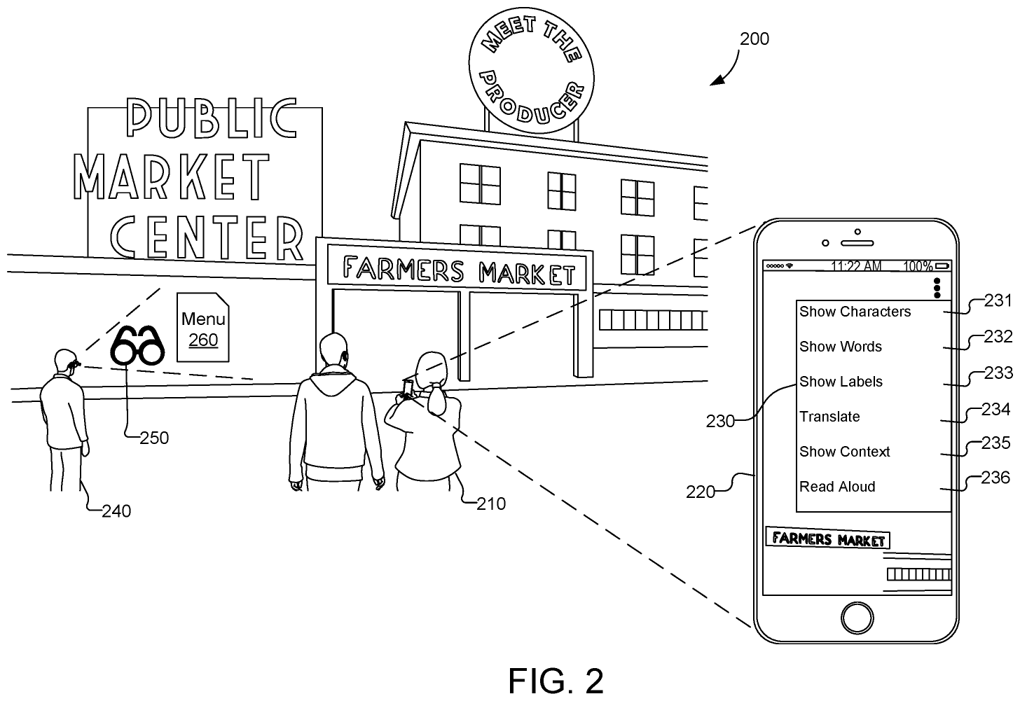

Further, image sensor 172 may include one or more sensors that convert an optical image into an electronic signal, such as CCD sensors for performing photon-to-electron conversion, or CMOS Image Sensor (CIS) for performing photon-to-voltage conversion. In this way, character manager 170 can directly capture images of a specific objects or the outdoor environment in general. User interface 174 is configured to enable a user to perform tasks related to text detection and recognition, e.g., based on machine learning engine 176. Various examples are further discussed in detail in connection with FIG. 2.

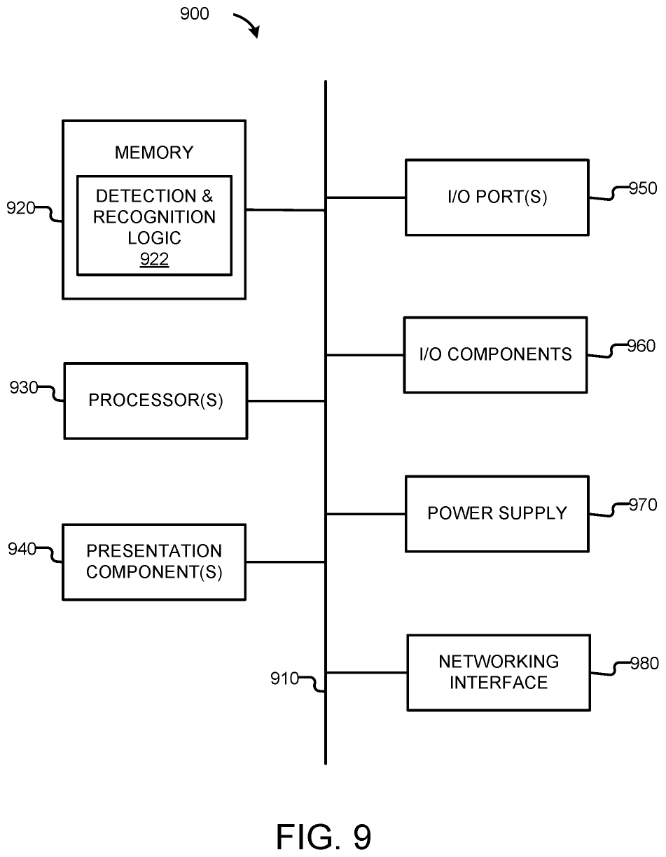

It should be understood that this operating environment shown in FIG. 1 is an example. Each of the devices or components shown in FIG. 1 may be implemented on any type of computing devices, such as computing device 900 described in FIG. 9, for example. Further, computer system 110 and mobile device 160 may communicate with each other or other devices or components in operating environment 100, such as data store 140, via communication network 130, which may include, without limitation, a local area network (LAN) or a wide area network (WAN). In exemplary implementations, WANs include the Internet and/or a cellular network, amongst any of a variety of possible public or private networks.

FIG. 2 illustrates some practical applications enabled by the disclosed character-based text detection and recognition technology. Further, a schematic representation is provided illustrating an exemplary user interface with various menu items for character-based text detection and recognition.

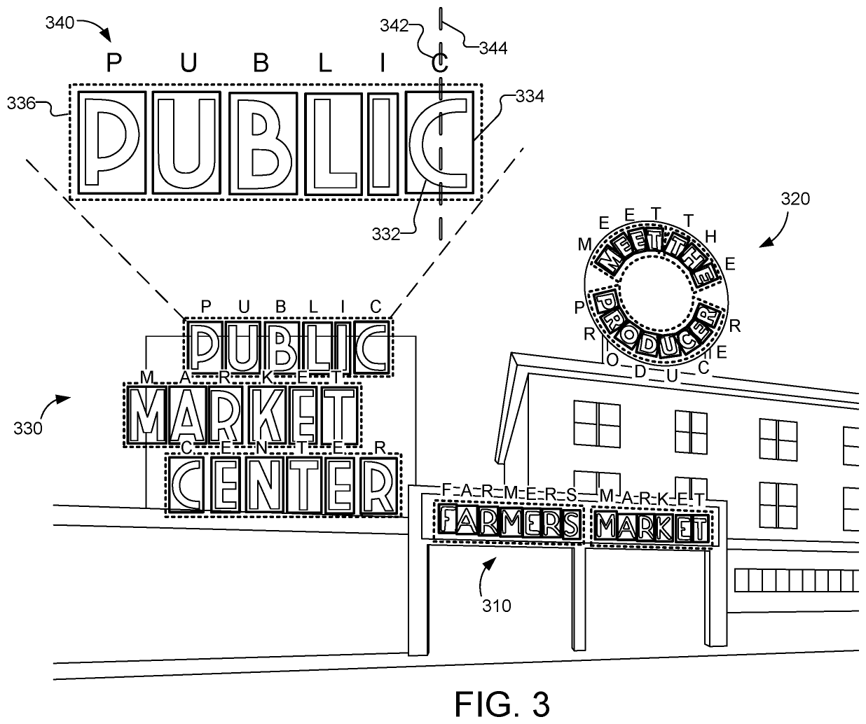

In one embodiment, user 210 uses mobile device 220 to view a scene. The real-time image is captured by mobile device 220. To use scene text detection and recognition functions, user 210 may activate menu 230. Menu item 231 is configured to show characters recognized from the scene. Menu item 232 is configured to show words recognized from the scene. In various embodiments, bounding boxes around characters or words may be used to show characters or words, as further illustrated in FIG. 3. Menu item 233 is configured to show labels created based on the scene text. In some embodiments, labels include typed scene text in a selected format. Labels may be displayed in the surrounding or nearby region of the recognized scene text.

Menu item 234 is configured to show scene text in a language different from the original language. A default translation language may be set by user 210. Another translation language may be selected after activating menu item 234. In some embodiments, a local translation app installed in mobile device 220 or a remote translation service may be invoked by menu item 234 to translate a part or all of the scene text. This practical application is useful for tourists to learn a new environment.

Menu item 235 is configured to show contextual information based on recognized scene text. Here, menu item 235 may cause the background information on the historical information of the farmers market to be displayed. In other embodiments, menu item 235 may cause the types of produce sold in the farmers market to be displayed. This practical application is useful to augment images with contextual information for mobile devices.

In some embodiments, mobile device 220, instead of showing a live image, may simply display a regular image, e.g., shared by a friend from a social network. By using the disclosed technologies, user 210 may learn additional knowledge of the displayed image based on scene text presented in the image.

In various embodiments, menu item 236 causes various audio outputs based on the recognized scene text. In one embodiment, after a particular object in the image is selected, menu item 236 is configured to read aloud the scene text on or around the selected object, e.g., via a text to speech engine on mobile device 220. In one embodiment, menu item 236 is to cause the scene text recognized from the image to be converted into an audio output in a particular sequence, e.g., from top to bottom. In some embodiments, the read aloud voice may be selected from any available translation languages as the recognized text can be translated into other languages. This practical application is useful for visually challenged users to understand an image or their surroundings.

In other embodiments, menu 260, with menu items similar or different from menu 230, may be displayed in the view of wearable device 250 worn by user 240. In this case, menu 260 may be invoked by a voice command or a gesture of user 240. Similarly, individual menu items of menu 260 may be activated by respective voice commands or gestures. This practical application is useful to augment images with contextual information for wearable devices.

The specific locations of various graphical user interface (GUI) components as illustrated are not intended to suggest any limitation as to the scope of design or functionality of these GUI components. It has been contemplated that various GUI elements may be changed or rearranged without limiting the advantageous functions provided by this example. As an example, menu item 236 may be displayed as a speaker-icon near a recognized word or text line, so that the user can selectively choose the recognized word or text line to be read aloud.

FIG. 3 illustrates an augmented image with recognized scene text, in accordance with at least one aspect of the technology described herein. In this image, multiple instances of scene text are detected and recognized. Instance 310 includes multiple characters aligned horizontally. Instance 320 includes curved text arranged in a circle. Instance 330 includes multiple segments of text arranged vertically.

Using instance 330 as an example, the top segment of text is magnified to illustrate further details. This segment of text includes six characters. Each character is enclosed by its character-level bounding box. As an example, character 332 is enclosed by its bounding box 334. As these characters form a word, i.e., public, the whole word is also enclosed by a word-level bounding box 336. Further, label 340 is added directly above this segment of text. In this embodiment, label 340 is composed from the typed letters responding to the detected characters. Thus, label 340 matches the scene text at character-level as well as word-level. However, in some embodiments, label 340 is composed from the translated text, which may match the scene text semantically, but not necessarily at character-level or word-level.

In the multiple instances of scene text in this image, the added labels are inserted into the image based on the respective orientations of the detected characters in some embodiments. To do that, each character in a label may be inserted at the extension line of its responding character in the scene text. By way of example, character 332 has the upright orientation. The imaginary extension line 344 of character 332 also extends vertically. Character 342 in label 340 may then be inserted into the image along the extension line 344, within a predetermined distance from character 332. In some embodiments, for curved text, the label may be inserted either above or below the detected scene text. Typically, this will result in a curved label as well. In some embodiments, regardless of the orientation of the scene text, labels may be inserted into images uniformly as horizontal text.

FIG. 4 is a schematic representation illustrating an exemplary network configured for character-based text detection and recognition, in accordance with at least one aspect of the technology described herein. Network 400 is configured for joint text detection and recognition. Because the identification of characters is of great importance for scene text recognition, network 400 is configured for direct character recognition with an automatic character localization mechanism, resulting in a simple yet powerful single-stage model.

In this embodiment, network 400 has a convolutional architecture that contains two branches, namely character branch 430 for character detection and recognition, and text branch 420 for text instance detection. Meanwhile, network 400 utilizes an iterative character detection method to automatically generate character bounding boxes in real-world images. In this context, text instance is used as a higher level text concept. A text instance may include words or text lines, which include one or more characters.

As previously discussed, existing approaches for joint text detection and recognition are commonly limited by using ROI operations and RNN-based sequential models for word recognition. In contrast, network 400 has a single-stage convolutional architecture consisting of two branches: character branch 430 configured for joint character-level detection and recognition, and text branch 420 configured to predict the locations of text instances, such as the locations of words, text lines, curved texts, etc.

The two branches, character branch 430 and text branch 420 are implemented in parallel, which form a single-stage model for joint text detection and recognition. Character branch 430 is integrated seamlessly into this single-stage model, resulting in an end-to-end trainable model that runs inference in one pass. In the inference stage, network 400 can directly output both instance-level and character-level bounding boxes, with corresponding character labels. In the training stage, this model uses both instance-level and character-level bounding boxes with character labels as supervised information.

Backbone 410 may use ResNet-50 or Hourglass networks. In some embodiments, ResNet-50 is used in backbone 410, and feature maps with a down-sample ratio (e.g., 4) may be used as the final feature maps for text detection and recognition. The fine-grained feature maps allow network 400 to detect and recognize extremely small-scale text instances. Moreover, in order to leverage strong semantic features in higher levels and more context information, the feature maps in higher levels may be laterally connected to the final feature maps. In some embodiments, Hourglass networks are used. Two hourglass modules may be stacked together. The final feature maps may be up-sampled (e.g., 0.25% of) based on the resolution of the input image. Different variants of Hourglass networks, e.g., Hourglass-88 and Hourglass-57, may be used. Further, Hourglass-104 may be modified to become Hourglass-88 by removing two down-sampling stages, and reducing the number of layers in the last stage of each hourglass module by half. Hourglass-57 may be constructed by further removing half the number of layers in each stage in each hourglass module. In some embodiments, the intermediate supervision is not employed.

Character branch 430 is configured for character detection and recognition. Character branch 430 uses characters as basic units for detection and recognition. In some embodiments, character branch 430 outputs character-level bounding boxes. In some embodiments, character branch 430 also outputs corresponding character labels. In some embodiments, character branch 430 may be implemented densely over the feature maps of the last upsampling layer by using a set of convolutional layers. For example, the input convolutional maps may be adopted from the last layer of backbone 410, which may have ¼ spatial resolution of the input image.

In some embodiments, character branch 430 contains three sub-branches: sub-branch 432 for text region segmentation, sub-branch 434 for character detection, and sub-branch 436 for character recognition. Each sub-branch may include a set of convolutional layers.

In one embodiment, sub-branch 432 and sub-branch 434 have the same configurations, by using three convolutional layers with filter sizes of 3×3, 3×3 and 1×1, whereas sub-branch 436 has four convolutional layers with one more 3×3 convolutional layer. Sub-branch 432 for text region segmentation may explore an instance-level binary mask as supervision and output 2-channel maps indicating text or non-text probability at each spatial location. Sub-branch 434 for character detection may output 5-channel maps, which predict a character location at each spatial location. Each character bounding box may be parameterized by five values, indicating the distances of a current point to the top, bottom, left, and right sides of the bounding box, with an orientation. Sub-branch 436 for character recognition may predict a character label at each spatial location of the feature maps, which may output 68-channel probability maps. Each channel is a probability map for a character label, and 68 character labels include 26 characters, 10 digital numbers, and 32 special symbols. Therefore, all the output maps from three sub-branches have a same spatial resolution which is the same as that of the input convolutional maps. The final character bounding boxes with corresponding labels can be computed from these maps.

Character branch 430 may be trained by using multi-level supervised information, including instance-level binary masks, character-level bounding boxes, and corresponding character labels. Compared to instance-level bounding boxes (e.g., words), character-level bounding boxes are more expensive to obtain and will increase manual cost inevitably. To reduce such cost, network 400 uses an iterative character detection mechanism which enables the model with the ability of automatic character detection by leveraging synthetic data, which will be further discussed in connection with FIG. 8. This allows network 400 to be trained in a weakly-supervised manner by just using instance-level bounding boxes with transcripts.

It is a challenge to directly group characters by using the available character bounding boxes, particularly when multiple text instances, which can have multiple orientations or be in a curved shape, are located closely within a region. Text branch 420 is configured to identify a text instance at a higher level concept, such as words or text lines. It provides strong context information which may be used to group the detected characters into text instances. Text branch 420 may be designed in different forms subjected to the type of text instances. Several exemplary detectors are disclosed here for word detection on multi-orientation or curved text.

For curved text 438, a direction field, which encodes the direction information that points away from the text boundary, is used to separate adjacent text instances in some embodiments. The direction field may be predicted in parallel with text detection and recognition tasks. In one embodiment, text branch 420 is composed of two 3×3 convolutional layers followed by another 1×1 convolutional layer for the final prediction.

In some embodiments, text branch 420 may use a modified EAST detector (see EAST: an efficient and accurate scene text detector. In Proc. CVPR, pages 2642-2651, 2017.) for multi-orientation word detection. Specifically, text branch 420 has two sub-branches in one embodiment: sub-branch 422 for text instance segmentation and sub-branch 424 for instance-level bounding box prediction, e.g., by using an Intersection Over Union (IoU) loss, which is designed to enforce the maximal overlap between the predicted bounding box and the ground truth, and jointly regress all the bound variables as a whole unit, as proposed by J. Yu, etc. in Unitbox: An advanced object detection network. In Proceedings of the 2016 ACM on Multimedia Conference, pages 516-520. ACM, 2016. 2, 4.

The predicted bounding boxes are parameterized by five parameters, including an orientation value. Text branch 420 may compute dense prediction at each spatial location of the feature maps, e.g., by using two 3×3 convolutional layers, followed by another ×1 convolutional layer. With such configurations, text branch 420 can output 2-channel segmentation maps and 5-channel detection maps for bounding boxes and orientations.

In this embodiment, output 440 from network 400 includes instance-level bounding boxes, character bounding boxes, and character labels. Output 440 is generated by applying the predicted instance-level bounding boxes (e.g., bounding boxes 428) to group the characters generated from character branch 430 into text instances. In one embodiment, a simple rule is adopted to assign a character to a text instance if it has a maximum IoU which is larger than 0.

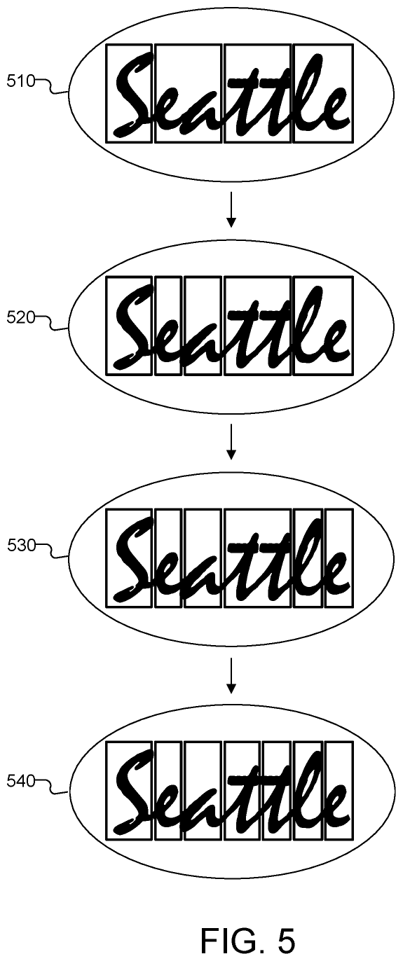

FIG. 5 is a schematic representation illustrating an exemplary iterative character learning process, in accordance with at least one aspect of the technology described herein. In this iterative character learning process, more characters have been learned in each iteration, from stage 510 to stage 520, then to stage 530, and finally to stage 540.

As discussed previously, network 400 may be trained by character-level and word-level bounding boxes, with corresponding character labels in some embodiments. However, character-level bounding boxes are expensive to obtain and are not available in many benchmark datasets, such as ICDAR 2015 and Total-Text. This disclosed iterative character detection method enables network 400 to automatically identify characters by leveraging from synthetic data, such as Synth800, where multi-level supervised information can be generated unlimitedly.

A straightforward approach is to train network 400 directly with synthetic images, and then make inference on real-world images. However, it has a large domain gap between the synthetic images and real ones, and the model trained on the synthetic images is difficult to work directly on the real-world ones. This rudimental approach likely will result in low performance.

An efficient training strategy is required to fill this domain gap. This iterative character learning model is to explore the generalization ability of a character detector to bridge the gap between two domains. In this process, character detection capability is gradually improved by increasingly using the real-world images. In various embodiments, the disclosed model is to identify reliable character-level bounding boxes based on the nature of text.

Because a word with a reliable or correct prediction generally contains a correct number of the predicted characters, the disclosed model can confirm corrected predictions based on the corresponding word script provided in word-level ground truth. The disclosed iterative character identification method is operated based on this confirmation principle. Instance-level samples may be collected gradually from a real-world dataset. By using words as text instances, the disclosed iterative progress can be described as follows.

First, the single-stage model is trained on the synthetic data, where multi-level supervised information is available. Then, the trained model may be applied to the training images from a real-world dataset to predict character-level bounding boxes with corresponding character labels.

Second, all detected characters from the “correct” words may be collected. In various embodiments, a correct word refers the numbers of predicted characters in the word is the same as its corresponding ground truth characters.

Third, the model may be trained further by using the collected characters and words from the real-world images, where the predicted character bounding boxes together with word-level bounding boxes and character labels provided from ground truth are available. In some embodiments, the predicted character labels are not used for training at this stage.

Fourth, this process is implemented iteratively to improve model capability gradually, which in turn continuously improves the quality of the predicted character-level bounding boxes, with an increasing number of the collected characters. Such iterations may continue until the number of the collected characters does not further increase. Similarly, character locations can be identified with a gradually improved accuracy.

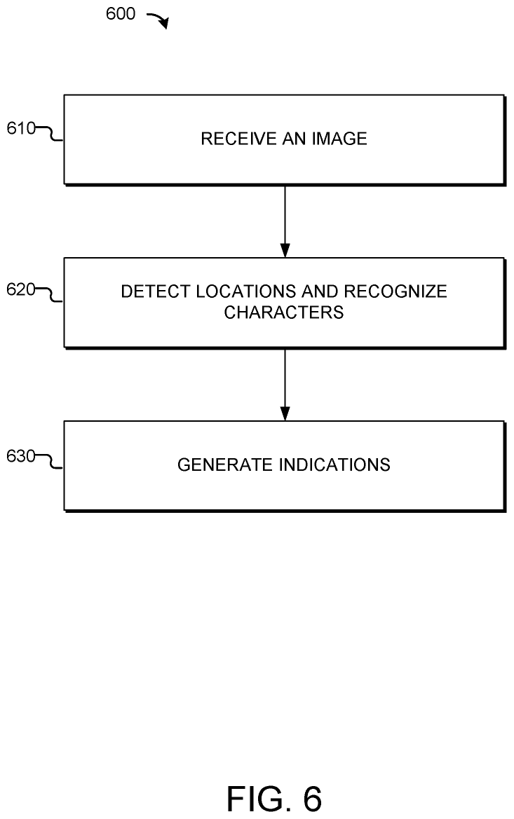

Referring now to FIG. 6, a flow diagram is provided that illustrates an exemplary process of character-based text detection and recognition. Each block of process 600, and other processes described herein, comprises a computing process that may be performed using any combination of hardware, firmware, or software. For instance, various functions may be carried out by a processor executing instructions stored in memory. The process may also be embodied as computer-usable instructions stored on computer storage media or devices. The process may be provided by an application, a service, or a combination thereof.

At block 610, an image may be received, e.g., by mobile device 160 of FIG.1, or mobile device 220 or wearable device 250 of FIG. 2. In various embodiments, the image contains scene text, such as illustrated in FIG. 2.

At block 620, respective locations of characters of the scene text in the image may be detected, and characters may be recognized, e.g., by character manager 170 of FIG. 1, or via network 400 of FIG. 4. In various embodiments, this character detection and recognition is performed jointly, e.g., via character branch 430 of FIG. 4.

At block 630, additional indications are generated based on the detected or recognized characters, e.g., by character manager 170 of FIG. 1, or via menu 230 of FIG. 2. In some embodiments, these indications include character-level bounding boxes or bounding boxes for text instances, such as words or text lines. In some embodiments, these indications include character labels or translated text instances. In some embodiments, these indications include contextual information, generated based on the detected or recognized characters, to argument the image. In various embodiments, such indications may be placed into the image at a calculated location, such as near the vicinity of the detected text instances.

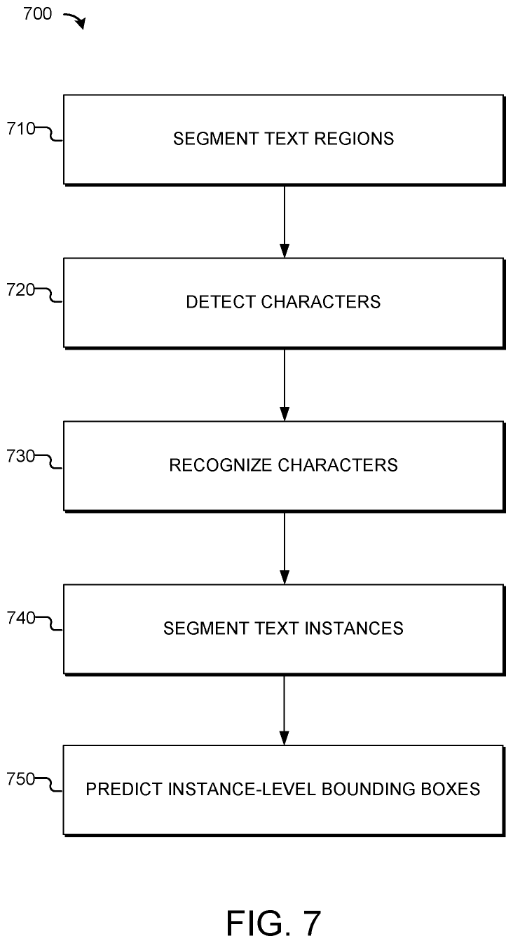

Turning now to FIG. 7, a flow diagram is provided to illustrate another exemplary process of character-based text detection and recognition. Each block of process 700, and other processes described herein, comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or a combination thereof.

At block 710, the process is to segment text regions from backgrounds, e.g., via sub-branch 432 of FIG. 4. Certain features are designed to distinguish text from backgrounds. Traditionally, such features may be manually designed to capture the properties of text. In various embodiments, deep learning based methods are used to learn distinguishable features from training data. In one embodiment, this process is to use instance-level binary masks in training data, and outputs 2-channel maps indicating text or non-text probability at each spatial location.

At block 720, the process is to detect characters, e.g., via sub-branch 434 of FIG. 4. Deep learning based methods may be used to detect characters, specifically the location of respective characters and their orientations. By way of example, a bounding box can be created around the text through the sliding window technique, single-shot detection techniques, region-based text detection techniques, etc. In one embodiment, this process is to output 5-channel maps, which predict a character location at each spatial location. Each character bounding box may be parameterized by five values, indicating the distances of current points to the top, bottom, left, and right sides of the bounding box, with an orientation.

At block 730, the process is to recognize characters, e.g., via sub-branch 436 of FIG. 4. Deep learning based methods may be used to recognize characters in their respective bounding boxes. In some embodiments, a Convolutional Recurrent Neural Network (CRNN) or another OCR engine is used for such text recognition tasks. This process is to predict a character label at each spatial location.

At block 740, the process is to segment text instances, e.g., via sub-branch 422 of FIG. 4. At block 750, the process is to predict instance-level bounding boxes, e.g., via sub-branch 424 of FIG. 4. Different from previous blocks, the process at block 740 and block 750 operates at instance-level, which could be at word-level, text-line-level, etc., depending on the implementation, although similar deep learning based methods may be adopted. Here, the process predicts instance-level bounding boxes at this stage.

Turning now to FIG. 8, a flow diagram is provided to illustrate another exemplary process of character-based text detection and recognition. Each block of process 800, and other processes described herein, comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or a combination thereof.

At block 810, the process is to build a model with synthetic data. In one embodiment, the model is pre-trained on synthetic data, e.g., Synth800k, for 5 epochs, where character-level annotations are available. Specifically, a mini-batch of 32 images, with 4 images per GPU, are used. The base learning rate is set to 0.0002. The learning rate is reduced according to Eq. 1, with power=0.9 in this embodiment.

base_lr×(1−iter/max_iter)^{power} Eq. 1

After the pre-training, the model is trained with a base learning rate of 0.002 on the training data provided by each real-world dataset, where the character-level annotations are identified automatically by the disclosed iterative character detection method. In some embodiments, data augmentation is also implemented.

The disclosed training process requires character-level annotations for training, which are not available in many benchmarks. As discussed previously, an efficient iterative method is developed to generate character-level annotations, e.g., character-level bounding boxes, by using word-level transcripts. The resulting model can accurately identify characters in scene text.

At block 820, the process is to run the trained model on real-world data. In various embodiments, the real-world data has word-level annotations only.

At block 830, the process is to collect correct words. In one embodiment, a word is considered to be correctly identified, and has character-level annotations, if the generated character-level annotation exactly match the transcripts of the word in both the number of characters and the character categories, since there is no ground-truth character-level annotation available on the dataset.

At block 840, the process is to provide feedback with correct words.

At block 850, the process is to check whether more characters have been recognized. If more characters are recognized in this iteration, the loop goes back to block 820. Otherwise, the loop goes to block 860.

At block 860, the process is to output the model.

Additional study with experimental results reveals that the performance is low if the model trained on the synthetic data is directly applied to the real-world data due to a large domain gap between them. However, the performance on both detection and end-to-end recognition are improved significantly when the model is trained with the disclosed iterative character detection method, which also allows the model to be trained on real-world images with just word-level annotations.

The efficacy of this iterative training method, in terms of its capability for automatically identifying the correct characters in real-world images, is further verified with additional studies. In these studies, a word is considered to be correctly identified, and has character-level annotations, if the generated character-level annotation matches the transcripts of the word in both the number of characters and the character categories, since there is no ground-truth character-level annotation available on the dataset.

By this criteria, in one study, there are only 64.95% words which are correctly identified by directly using the model trained on synthetic data at iteration 0. This number is increased considerably from 64.95% to 88.94%, when the iterative character detection method is applied during training. This also leads to a significant performance improvement, from 39.3% to 62.9% on end-to-end recognition on Total-Text. The training process continues until the number of the identified words does not increase further. Finally the model collects 92.65% words with character-level annotations among all training images in the Total-Text.

Accordingly, we have described various aspects of the technology for detecting mislabeled products. It is understood that various features, sub-combinations, and modifications of the embodiments described herein are of utility and may be employed in other embodiments without reference to other features or sub-combinations. Moreover, the order and sequences of steps shown in the above example processes are not meant to limit the scope of the present disclosure in any way, and in fact, the steps may occur in a variety of different sequences within embodiments hereof. Such variations and combinations thereof are also contemplated to be within the scope of embodiments of this disclosure.

Referring to FIG. 9, an exemplary operating environment for implementing aspects of the technology described herein is shown and designated generally as computing device 900. Computing device 900 is but one example of a suitable computing environment and is not intended to suggest any limitation as to the scope of use of the technology described herein. Neither should the computing device 900 be interpreted as having any dependency or requirement relating to any one or combination of components illustrated.

The technology described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, and specialty computing devices, etc. Aspects of the technology described herein may also be practiced in distributed computing environments where tasks are performed by remote-processing devices that are connected through a communications network.

With continued reference to FIG. 9, computing device 900 includes a bus 910 that directly or indirectly couples the following devices: memory 920, processors 930, presentation components 940, input/output (I/O) ports 950, I/O components 960, and an illustrative power supply 970. Bus 910 may include an address bus, data bus, or a combination thereof. Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. The inventors hereof recognize that such is the nature of the art and reiterate that the diagram of FIG. 9 is merely illustrative of an exemplary computing device that can be used in connection with different aspects of the technology described herein. Distinction is not made between such categories as “workstation,” “server,” “laptop,” “handheld device,” etc., as all are contemplated within the scope of FIG. 9 and refers to “computer” or “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 920 includes computer storage media in the form of volatile and/or nonvolatile memory. The memory 920 may be removable, non-removable, or a combination thereof. Exemplary memory includes solid-state memory, hard drives, optical-disc drives, etc. Computing device 900 includes processors 930 that read data from various entities such as bus 910, memory 920, or I/O components 960. Presentation component(s) 940 present data indications to a user or other device. Exemplary presentation components 940 include a display device, speaker, printing component, vibrating component, etc. I/O ports 950 allow computing device 900 to be logically coupled to other devices, including I/O components 960, some of which may be built in.

In various embodiments, memory 920 includes, in particular, temporal and persistent copies of detection and recognition logic 922. Detection and recognition logic 922 includes instructions that, when executed by processors 930, result in computing device 900 performing functions, such as, but not limited to, processes 600, 700, and 800 as discussed herein; various functions or processes as discussed in connection with FIGS. 2-5.

Further, in various embodiments, detection and recognition logic 922 includes instruction that, when executed by processors 930, result in computing device 900 performing various functions associated with, but not limited to machine learning engine 120, character manager 170, or their respective sub-components, in connection with FIG. 1; wearable device 250 or mobile device 220 in connection with FIG. 2; text branch 420 or character branch 430 in connection with FIG. 4.

In some embodiments, processors 930 may be packed together with detection and recognition logic 922. In some embodiments, processors 930 may be packaged together with detection and recognition logic 922 to form a System in Package (SiP). In some embodiments, processors 930 cam be integrated on the same die with detection and recognition logic 922. In some embodiments, processors 930 can be integrated on the same die with detection and recognition logic 922 to form a System on Chip (SoC).

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processors 930 may be direct or via a coupling utilizing a serial port, parallel port, and/or other interface and/or system bus known in the art. Furthermore, the digitizer input component may be a component separate from an output component such as a display device. In some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

Computing device 900 may include networking interface 980. The networking interface 980 includes a network interface controller (NIC) that transmits and receives data. The networking interface 980 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 980 may include a wireless terminal adapted to receive communications and media over various wireless networks. Computing device 900 may communicate with other devices via the networking interface 980 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, 5G NR (New Radio) protocols, etc.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. A computer-implemented method for text detection and recognition, comprising:
receiving an image with a representation of a word having a plurality of characters;
based on a machine learning model with an iterative character learning approach, detecting a location of a character of the plurality of characters and concurrently recognizing the character; and
generating an indication of the location of the character.

2. The method of claim 1, wherein the iterative character learning approach comprises learning from synthetic data with character labels prior to learning from real-world data.

3. The method of claim 1, wherein the iterative character learning approach comprises iteratively improving a count of correctly recognized characters.

4. The method of claim 1, wherein the iterative character learning approach comprises stopping further iterations of learning when a total number of recognized characters does not increase from a prior iteration.

5. The method of claim 1, wherein the iterative character learning approach comprises comparing a first count of characters in a recognized word with a second count of characters in a corresponding ground truth word.

6. The method of claim 5, wherein the iterative character learning approach comprises using the recognized word as a positive example in a next iteration of machine learning when the first count equates to the second count.

7. The method of claim 1, wherein detecting the location and concurrently recognizing the character are based on one or more shared convolutional features, and the one or more shared convolutional features comprise character-level bounding boxes.

8. The method of claim 1, wherein the indication comprises a character-level bounding box for the character, and the method further comprising:
adding a corresponding character within a predetermined distance to the character-level bounding box, wherein the corresponding character is the recognized character.

9. The method of claim 8, wherein the image comprises a product, and the method further comprising:
recognizing the product based on the word having the plurality of characters.

10. A computer-readable storage device encoded with instructions that, when executed, cause one or more processors of a computing system to perform operations comprising:
receiving an image with a representation of a word with a plurality of characters;
detecting respective locations of the plurality of characters in the image and recognizing the plurality of characters at a character-level in a single stage of processing; and
generating a first indication of the word and a second indication of the respective locations of the plurality of characters.

11. The computer-readable storage device of claim 10, wherein detecting the respective locations and recognizing the plurality of characters further comprise:
determining text probability at a spatial location;
identifying a character location at the spatial location; and
generating a multi-channel probability map for the character location, wherein a channel of the multi-channel probability map represents a probability associated with a character.

12. The computer-readable storage device of claim 10, wherein detecting the respective locations and recognizing the plurality of characters is based on a machine learning model with multi-level supervised information, wherein the multi-level supervised information includes text-instance-level location information, character-level location information, and corresponding characters information.

13. The computer-readable storage device of claim 10, wherein the operations further comprising:
detecting text instances with multi-orientations or with different curvatures.

14. The computer-readable storage device of claim 10, wherein the generating further comprises:
combining text-instance-level features with character-level features to form the first indication and the second indication.

15. The computer-readable storage device of claim 10, wherein the first indication comprises a bounding box of the word, and the second indication comprises respective character-level bounding boxes for each of the plurality of characters.

16. A system for text detection and recognition, comprising:
a memory; and
one or more processors configured to:
receive an image with a representation of a word;
detect locations of a plurality of characters in the word and concurrently recognize the plurality of characters;
generate respective character-level bounding boxes for the plurality of characters; and
generate a word-level bounding box for the word.

17. The system of claim 16, wherein the one or more processors are further configured to:
add character-level annotations to the plurality of characters.

18. The system of claim 16, wherein generating the respective character-level bounding boxes is in response to a user selection of a user option for augmenting the image with character-level information.

19. The system of claim 16, wherein generating the word-level bounding box is in response to a user selection of a user option for augmenting the image with word-level information.

20. The system of claim 16, wherein the system comprises a mobile device or a wearable device.
